(19) United States
(12) Patent Application Publication
(10) Pub. No.: US 2013/0278446 A1
(43) Pub. Date: Oct. 24, 2013

(54) VEHICULAR OBSERVATION SYSTEM, APPARATUS, AND SERVER FOR THE VEHICULAR OBSERVATION SYSTEM

(71) Applicant: YUH-SHYING GAU, Tu-Cheng (TW)

(72) Inventor: YUH-SHYING GAU, Tu-Cheng (TW)

(73) Assignee: HON HAI PRECISION INDUSTRY CO., LTD., Tu-Cheng (TW)

(21) Appl. No.: 13/450,751

(22) Filed: Apr. 19, 2012

(51) Int. Cl. B60R 25/04; G08G 1/123; B60R 25/10

(52) U.S. Cl. 340/989; 340/426.18; 340/426.11

(57) ABSTRACT

An observation system for a vehicle is provided. The observation system includes an observation apparatus and a server. The observation apparatus includes a location identification unit producing a location information and a movement identification unit producing a movement information. The observation apparatus transmits a first movement warning message including the location information to the server when the movement information matches a burglar model, and transmits a second movement warning message to the server when the movement information matches a suspicious burglar model. The server compares a vehicle information with an advanced burglar model in response to the second movement warning message. The disclosure further provides an observation apparatus and a server for the observation system.

### CROSS-REFERENCE OF RELATED APPLICATIONS

Relevant subject matters are disclosed in a co-pending U.S. patent application Ser. No. (Attorney Docket No. US44973), which is assigned to the same assignee as this patent application.

### BACKGROUND

1. Technical Field

The present disclosure relates to an observation system and an observation method, and particularly to an observation system and an observation method for a vehicle.

2. Description of Related Art

Most present observation systems for vehicles such as motorcycles and cars merely provide simple mechanisms such as lock assemblies, and vehicles with such systems can be stolen relatively easily. In addition, such systems are incapable of providing the location of the vehicle when stolen.

What is needed, therefore, is a vehicular observation system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a vehicular observation system of the present disclosure.

FIG. 2 is a block diagram of an embodiment of the movement identification unit shown in FIG. 1.

FIG. 3 is a flowchart of a first embodiment of a vehicular observation method implemented through the vehicular observation system shown in FIG. 1.

FIG. 4 is a flowchart of an embodiment of step S1130 of FIG. 3 implemented through the vehicular observation system shown in FIG. 2.

FIG. 5 is a flowchart of an embodiment of step S1160 of FIG. 3 implemented through the vehicular observation system shown in FIG. 2.

FIG. 6 is a flowchart of a second embodiment of a vehicular observation method implemented through the vehicular observation system shown in FIG. 1.

FIG. 7 is a flowchart of a third embodiment of a vehicular observation method implemented through the vehicular observation system shown in FIG. 1.

### DETAILED DESCRIPTION

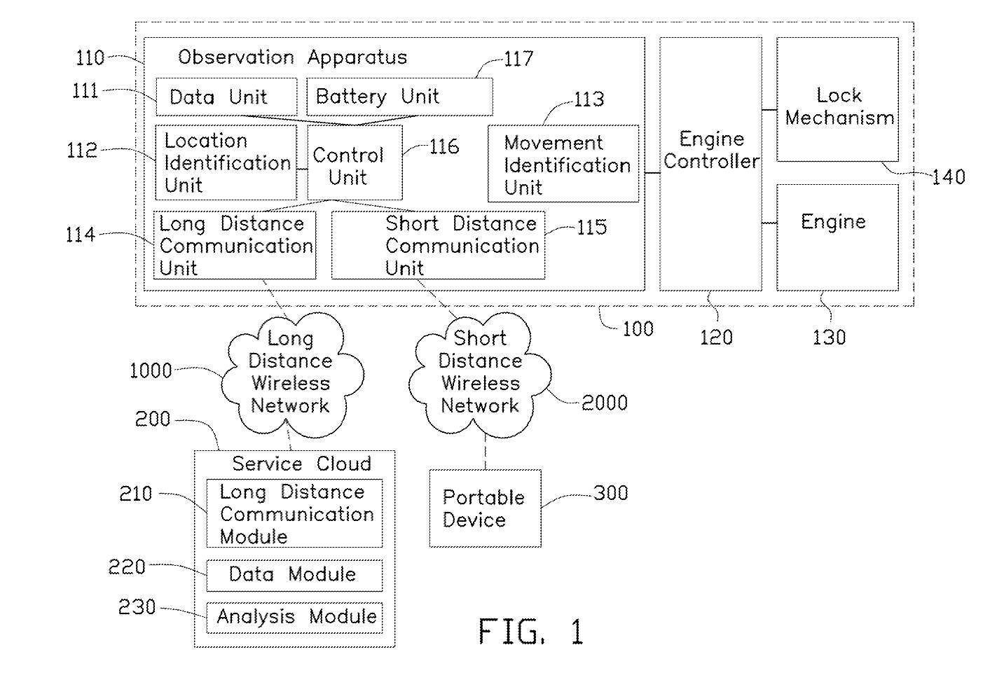

FIG. 1 is a schematic diagram of a vehicular observation system of the present disclosure. In the illustrated embodiment, the vehicular observation system is applied to a motorcycle 100. In other embodiments, the vehicular observation system can be applied to any other vehicles such as cars. The vehicular observation system includes the motorcycle 100 and a service cloud 200 which includes one or more servers. The motorcycle 100 includes an observation apparatus 110, an engine controller 120, an engine 130, and a lock mechanism 140. In the illustrated embodiment, the observation apparatus 110 is disposed inside the motorcycle 100 for example under a seat of the motorcycle 1. In other embodiments, the observation apparatus 110 can be disposed in other ways. For instance, the observation apparatus 110 can be disposed inside a dashboard of the motorcycle 100. The engine controller 120 operates the engine 130 by, for instance, starting/stopping the engine 130 and/or adjusting the speed of the engine 130. The lock mechanism 140 can be unlocked to allow the engine 130 to be started through the engine controller 120 and locked to stop the engine 130 through the engine controller 120.

The observation apparatus 110 includes a data unit 111, a location identification unit 112, a movement identification unit 113, a long distance wireless communication unit 114, a short distance wireless communication unit 115, a control unit 116, and a battery unit 117. The data unit 111 stores the working parameters of the motorcycle 100. The working parameters includes status models of the motorcycle 100 and all data relating thereto such as data emanating from the location identification unit 112 and from the movement identification unit 113. The location identification unit 112 is a GPS (Global Positioning System) receiver which is capable of producing a location information I₁ (not shown) representing a latitude, a longitude, and/or an elevation of the motorcycle 1. In other embodiments, the location identification unit 112 can be another type of location identification devices such as WPS (Wi-Fi Positioning System) receiver, while the location information I₁ can include other type of locational data of the motorcycle 1. The movement identification unit 113 is capable of producing a movement information Iₘ (not shown) which represents any significant motion of the motorcycle 1.

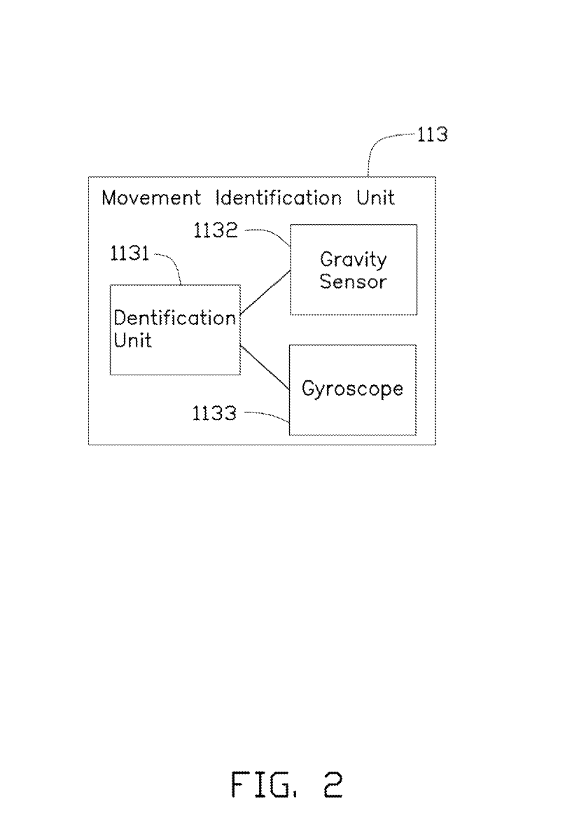

FIG. 2 is a block diagram of an embodiment of the movement identification unit 113 shown in FIG. 1. The movement identification unit 113 of the observation apparatus 110 of the motorcycle 100 includes an identification unit 1131, a gravity sensor 1132, and a gyroscope 1133. The gravity sensor 1132 can produce an inertia information Iᵢ (not shown), and the gyroscope 1133 can produce an orientation information Iₒ (not shown), such that the movement information Iₘ includes the inertia information Iᵢ and the orientation information Iₒ. In the illustrated embodiment, the components of the observation apparatus 110 are in a sleep mode, which consumes minimal electricity when the motorcycle 100 is not in operation. When the gravity sensor 1132 is disturbed from the status quo and thus actuated, the other components of the observation apparatus 110 are actuated when needed. For instance, the long distance wireless communication unit 114 and the short distance wireless communication unit 115 are actuated only when it is necessary to transmit messages.

The long distance communication unit 114 is capable of communicating with the service cloud 200 through a long distance wireless network 1000 implemented according to a telecommunication standard such as GSM (Global System for Mobile Communications) or Wi-Fi. In the illustrated embodiment, the long distance communication unit 114 includes a SIM (Subscriber Identity Module) card as an identifier of the observation apparatus 110. The short distance communication unit 115 is capable of communicating with a portable device 300 through a short distance wireless network 2000 implemented according to a telecommunication standard such as BLUETOOTH. The portable device 300 can be a mobile phone or a helmet and visor with a head-up display (HUD).

Table 1, below, shows the status models of the motorcycle 100 shown in FIG. 1. In the illustrated embodiment, the status models include a normal model Dₙ, a burglar model D_{b}, and a suspicious burglar model Dₛ. The normal model Dₙ represents the motorcycle 100 being in operation when, for instance, the lock mechanism 140 is unlocked. The normal model Dₙ defines a first lock/engine state requiring the lock mechanism 140 to be unlocked when the engine 130 is started. If the states of the lock mechanism 140 and the engine 130 correspond to the first lock/engine state, the status of the motorcycle 100 is determined as matching the normal model Dₙ. When the motorcycle 100 is not in operation which, for instance, the lock mechanism 140 is unlocked, the control unit 116 enables the long distance wireless communication unit 114 to transmit a first movement warning message M1 to the service cloud 200 when the movement information Iₘ matches the burglar model Db. In addition, the control unit 116 enables the long distance wireless communication unit 114 to transmit a second movement warning message M2 to the service cloud 200 when the movement information Iₘ matches the suspicious burglar model Dₛ.

TABLE 1

| Status | Normal | Burglar Model D_{b} | | Suspicious Burglar |
|---|---|---|---|---|
| Models | Model Dₙ | 1 | 2 | Model Dₛ |
| Speed | N/A | 0 | N/A | 0 |
| Inertia | N/A | Keep Changing | N/A | Keep Changing |
| Location | N/A | Keep Changing | N/A | Keep Changing |
| Orientation | N/A | Keep Changing | N/A | Keep Changing |
| Engine | On | Off | On | Off |
| Lock | Unlocked | Locked | Locked | Unlocked |

The burglar model D_{b} defines a set of a first location variation values, a first inertia variation value, a first orientation variation value, an observation period, and a second lock/engine state, wherein the second lock/engine state represents the lock mechanism 140 being unlocked while the engine 130 is stopped. If the location information I₁, the inertia information Iᵢ, and the orientation information Iₒ respectively exceed the first location variation value, the first inertia variation value, and the first orientation variation value during the observation period, and the states of the lock mechanism 140 and the engine 130 correspond to the second lock/engine state, the status of the motorcycle 100 is determined as matching the burglar model D_{b}, and the control unit 116 of the observation apparatus 110 can transmit the first movement warning message M1 including the location information I₁ to the service cloud 200. As a result, the service cloud 200 can inform a client such as the owner of the motorcycle 1 accordingly, through, for example, the portable device 300 or other electronic devices capable of communicating with the service cloud 200. The burglar model D_{b} corresponds to the likelihood of irregular conduct such as an attempt to move the motorcycle 100 by, for instance, towing the motorcycle 100 along the road or lifting it by a crane or otherwise. In addition, the burglar model D further defines a set of third lock/engine state, wherein the third lock/engine state represents the lock mechanism 140 being applied or locked while the engine 130 being started. If the states of the lock mechanism 140 and the engine 130 correspond to the third lock/engine state, the status of the motorcycle 100 is determined as matching the burglar model which corresponds to the likelihood of irregular attempts to start the engine 130 by hacking the lock mechanism 140.

The suspicious burglar model Dₛ defines a set of a second location variation values, a second inertia variation value, a second orientation variation value, an observation period, and a fourth lock/engine state, wherein the fourth lock/engine state represents the lock mechanism 140 being unlocked when the engine 130 is stopped. If the location information I₁, the inertia information Iᵢ, and the orientation information Iₒ respectively exceed the second location variation value, the second inertia variation value, and the second orientation variation value during the observation period, and the states of the lock mechanism 140 and the engine 130 correspond to the fourth lock/engine state, the status of the motorcycle 100 is determined as matching the suspicious burglar model Dₛ. When the status of the motorcycle 100 matches the suspicious burglar model, in the illustrated embodiment, the control unit 116 of the observation apparatus 110 transmits the second movement warning message M2 including the location information I₁ to the service cloud 200. In other embodiments, the second movement warning message M2 can further include other parameters of the motorcycle 100 such as the movement information Iₘ. The suspicious burglar model Dₛ corresponds to the likelihood of an irregular or unlawful attempt to move the motorcycle 100 by, for instance, towing the motorcycle 100 along the road by a person when the lock mechanism 140 is applied or locked.

The service cloud 200 includes a long distance wireless communication module 210, a data module 220, and an analysis module 230. The long distance communication module 210 communicates with the observation apparatus 110 of the motorcycle 100 through the long distance communication unit 114 of the observation apparatus 110. The data module 220 stores an advanced burglar model Dₐ (not shown) and a vehicle information Iᵥ (not shown). The vehicle information Iᵥ can include the statuses of the motorcycle 100 received from the observation apparatus 110 and/or an extra electronic device, for example, location obtained from the location information I₁, movement obtained from the movement information Iₘ, mileage accumulated, speed, engine oil pressure, battery state of charge, temperature, or video taken from the motorcycle 100. The electronic extra device can be, for example, a camera disposed in a scene where the motorcycle 100 is located. In the illustrated embodiment, the vehicle information Iᵥ includes the location information I₁ received from the observation apparatus 110 and a usage record of the motorcycle 1. The analysis module 230 of the service cloud 200 compares the vehicle information Iᵥ with the advanced burglar model Dₐ in response to the second movement warning message M2 received from the observation apparatus 110 of the motorcycle 100.

The advanced burglar model Dₐ defines a usage habit of the motorcycle 1, for example, the usual times of use and the locations where the motorcycle 1 is usually used. If the vehicle information Iᵥ is not within the domain of the usage habit, for instance, the engine 130 is determined to be started at an irregular time and an irregular location which is determined by comparing the location information I₁ and the current time with the usage record, the status of the motorcycle 100 is determined as matching the advanced burglar model Dₐ, and the service cloud 200 can inform a client such as the owner of the motorcycle 1, through, for example, the portable device 300 or other electronic devices capable of communicating with the service cloud 200.

When the motorcycle 100 is in operation which, for instance, the lock mechanism 140 is unlocked, and the long distance communication unit 114 of the observation apparatus 110 of the motorcycle 100 receives an engine stopping instruction from the service cloud 200, the observation apparatus 110 acts on the engine controller 110 to stop the engine 130, and disables the engine controller 110. When the engine controller 110 is disabled in response to receiving the engine stopping instruction, the engine controller 110 can be enabled again only when a password which is input through, for example, a dashboard of the motorcycle 100 or the portable device 300, in fact matches an unlock password. Consequently, a thief riding the motorcycle 100 away will not be able to travel very far.

In the illustrated embodiment, the observation apparatus 110 is normally powered by a battery of the motorcycle 1. When an attempt to disconnect the battery from the observation apparatus 110 is detected, the battery unit 117 such as a LiFePO₄ battery is used as a substitute to power the observation apparatus 110, and the observation apparatus 110 transmits a warning message to the service cloud 200, such that the service cloud 200 can inform a client such as the owner of the motorcycle 1. In addition, the working parameters stored in the data unit 111 of the observation apparatus 110 can be modified through the portable device 300 by receiving an input from the portable device 300 and modifying the parameters according to the input. In other embodiments, the working parameters can be modified through other type of electronic devices such as computers, while the connection between the observation apparatus 110 and the electronic device can be another type of interfaces such as a wired interface(s). Furthermore, the service cloud 200 can transmit a location inquiry instruction to the observation apparatus 110 in response to a location request received from the portable device 300. The observation apparatus 110 transmits the location information I₁ to the service cloud 200 in response to the location inquiry instruction, such that the service cloud 200 can reply to the location requirement of the portable device 300 according to the location information I₁. As a result, the location of the motorcycle 100 can always be provided to the owner of the motorcycle 100 through the portable device 300 by, for instance, displaying a map including an icon representing the location of the motorcycle 100 on a display of the portable device 300.

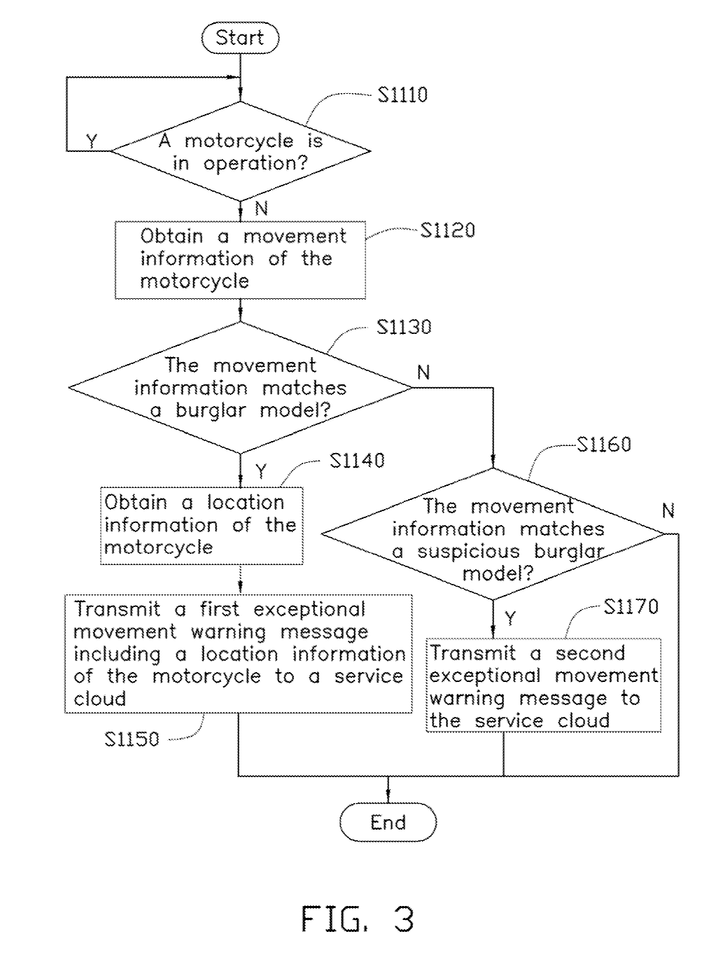

FIG. 3 is a flowchart of a first embodiment of a vehicular observation method implemented through the vehicular observation system shown in FIG. 1. The vehicular observation method of the present disclosure follows. Depending on the embodiment, additional steps may be added, others removed, and the ordering of the steps may be changed.

In step S1110, a determination is made as to whether the motorcycle 100 is in operation. If no, step S1120 is implemented; otherwise, the method remains in step S1110.

In step S1120, the movement information Iₘ of the motorcycle 100 is obtained;

In step S1130, a determination is made as to whether the movement information Iₘ matches the burglar model D_{b}. If it does match, step S1140 is implemented; otherwise, step S1160 is implemented.

In step S1140, the location information I₁ of the motorcycle 100 is obtained.

In step S1150, the first movement warning message M1 including the location information I₁ is transmitted to a service cloud 200.

In step S1160, a determination is made as to whether the movement information Iₘ matches the suspicious burglar model Dₛ. If it does match, step S1170 is implemented; otherwise, the method is terminated.

In step S1170, the second movement warning message M2 including the location information I₁ is transmitted to the service cloud 200.

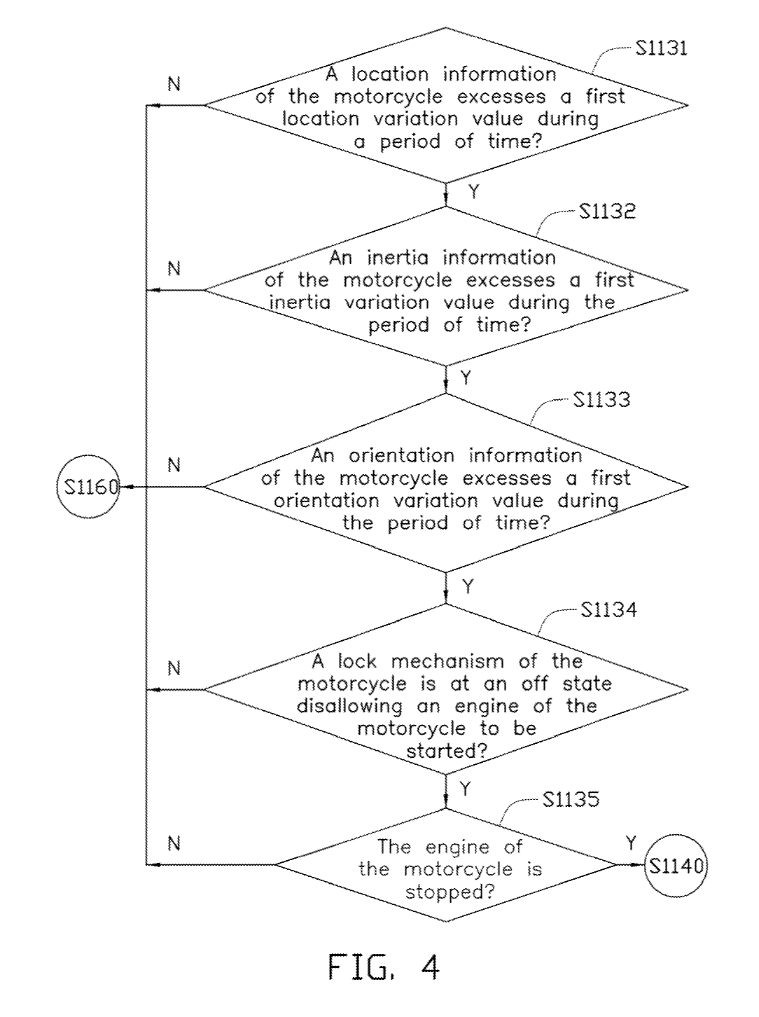

FIG. 4 is a flowchart of an embodiment of step S1130 of FIG. 3 implemented through the vehicular observation system shown in FIG. 2. The vehicular observation method of the present disclosure follows. Depending on the embodiment, additional steps may be added, others removed, and the ordering of the steps may be changed.

In step S1131, a determination is made as to whether the location information I₁ of the motorcycle 100 exceeds a first location variation value during a certain period of time. If yes, step S1132 is implemented; otherwise, step S1160 is implemented.

In step S1132, a determination is made as to whether the inertia information Iᵢ of the motorcycle 100 exceeds a first inertia variation value during the certain period of time. If yes, step S1133 is implemented; otherwise, step S1160 is implemented.

In step S1133, a determination is made as to whether the orientation information Iₒ of the motorcycle 100 exceeds a first orientation variation value during the certain period of time. If yes, step S1134 is implemented; otherwise, step S1160 is implemented.

In step S1134, a determination is made as to whether the lock mechanism 140 is applied, that is to say locked, thus preventing the engine 130 from being started. If yes, step S1135 is implemented; otherwise, step S1160 is implemented.

In step S1135, a determination is made as to whether the engine 130 is stopped. If yes, step S1140 is implemented; otherwise, step S1160 is implemented.

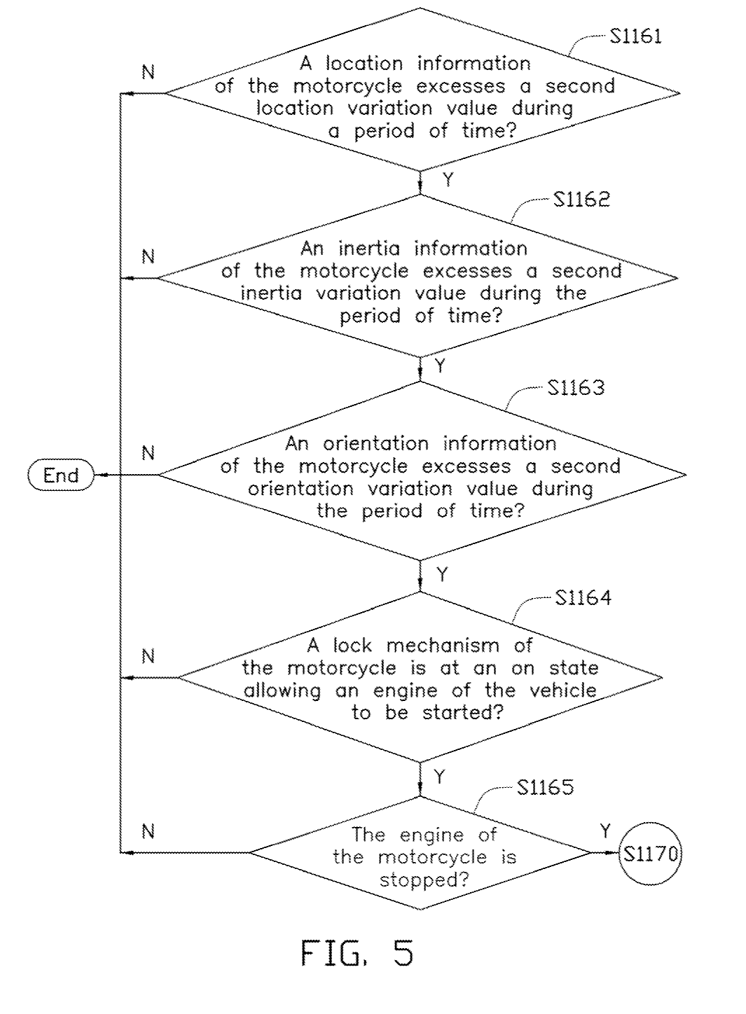

FIG. 5 is a flowchart of an embodiment of step S1160 of FIG. 3 implemented through the vehicular observation system shown in FIG. 2. The vehicular observation method of the present disclosure follows. Depending on the embodiment, additional steps may be added, others removed, and the ordering of the steps may be changed.

In step S1161, a determination is made as to whether the location information I₁ of the motorcycle 100 exceeds a second location variation value during a certain period of time. If yes, step S1162 is implemented; otherwise, the method is terminated.

In step S1162, a determination is made as to whether the inertia information Iᵢ of the motorcycle 100 exceeds a second inertia variation value during the certain period of time. If yes, step S1163 is implemented; otherwise, the method is terminated.

In step S1163, a determination is made as to whether the orientation information Iₒ of the motorcycle 100 exceeds a second orientation variation value during the period of time. If yes, step S1164 is implemented; otherwise, the method is terminated.

In step S1164, a determination is made as to whether the lock mechanism 140 is unlocked to allow the engine 130 to be started. If yes, step S1165 is implemented; otherwise, the method is terminated.

In step S1165, a determination is made as to whether the engine 130 is stopped. If yes, step S1170 is implemented; otherwise, the method is terminated.

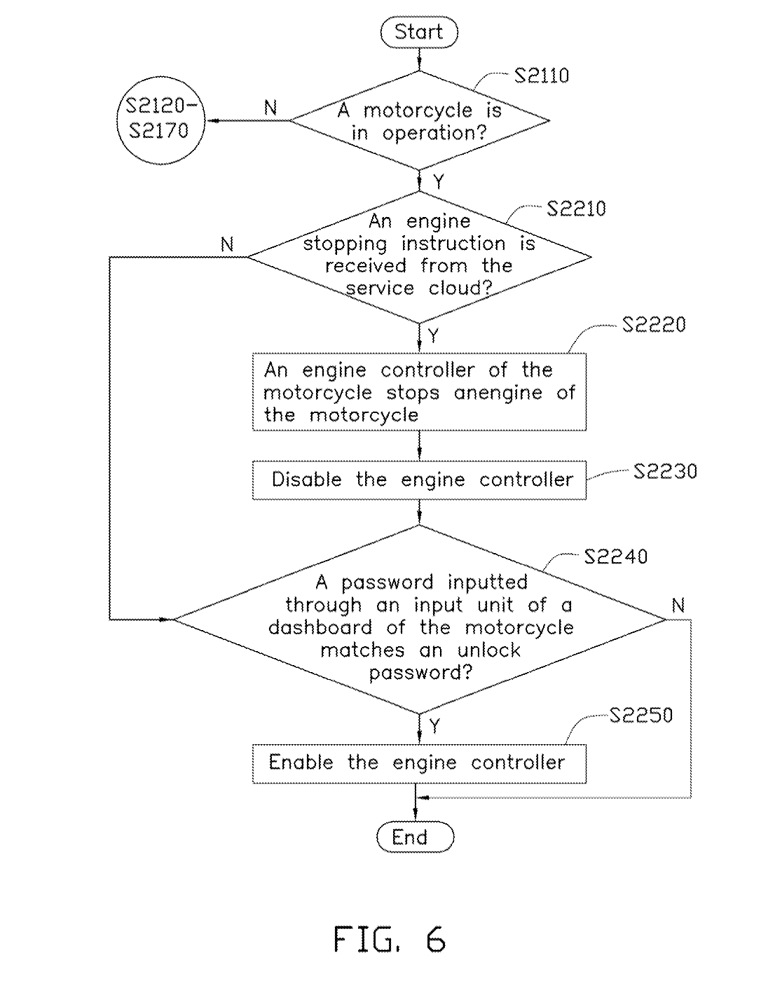

FIG. 6 is a flowchart of a second embodiment of a vehicular observation method implemented through the vehicular observation system shown in FIG. 1. The vehicular observation method of the present disclosure follows. Depending on the embodiment, additional steps may be added, others removed, and the ordering of the steps may be changed.

Steps S2120-S2170 correspond to steps S1120-S1170 of FIG. 3, as detailed above, and will not be repeated hereinafter.

In step S2110, a determination is made as to whether the motorcycle 100 is in operation. If yes, step S2210 is implemented; otherwise, step S2120 is implemented.

In step S2210, a determination is made as to whether an engine stopping instruction has been received from the service cloud 200. If such an instruction has been received, step S2220 is implemented; otherwise, step S2240 is implemented.

In step S2220, the engine controller 120 stops the engine 130 of the motorcycle 100.

In step S2230, the engine controller 120 is disabled.

In step S2240, a determination is made as to whether any password which has been input through an input unit of a dashboard of the motorcycle 100 matches an unlock password. If a match is found, step S2250 is implemented; otherwise, the method is terminated. In other embodiments, the password can be input through the portable device 300.

In step S2250, the engine controller 110 is enabled.

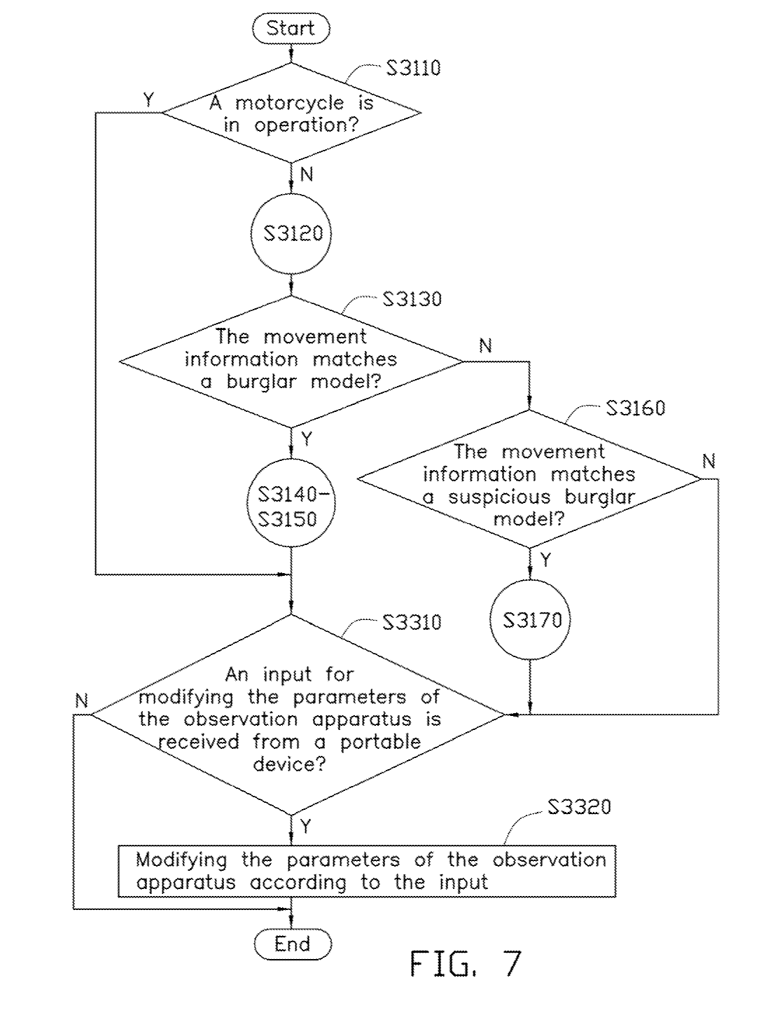

FIG. 7 is a flowchart of a third embodiment of a vehicular observation method implemented through the vehicular observation system shown in FIG. 1. The vehicular observation method of the present disclosure follows. Depending on the embodiment, additional steps may be added, others removed, and the ordering of the steps may be changed.

Steps S3120, S3140-S3150, and S3170 correspond to steps S1120, S1140-S1150, and S1170 of FIG. 3, as detailed above, and will not be repeated hereinafter.

In step S3110, a determination is made as to whether the motorcycle 100 is in operation. If no, step S3120 is implemented; otherwise, step S3310 is implemented.

In step S3130, a determination is made as to whether the movement information Iₘ matches the burglar model D_{b}. If it does match, step S3140 is implemented; otherwise, step S3160 is implemented.

In step S3160, a determination is made as to whether the movement information Iₘ matches the suspicious burglar model Dₛ. If it does match, step S3170 is implemented; otherwise, step S3310 is implemented.

In step S3310, a determination is made as to whether an input for modifying the parameters of the observation apparatus 110 has been received from the portable device 300. If an input has been received, step S3320 is implemented; otherwise, the method is terminated.

In step S3320, the parameters of the observation apparatus 110 are modified according to the input.

The vehicular observation system and the vehicular observation method provide almost complete vehicle security through transmitting the first movement warning message M1 and the second movement warning message M2 to the service cloud 200, such that a owner of the motorcycle 100 as the client can be informed by the service cloud 200 when an irregular attempt to start the engine 130 of the motorcycle 100 is recognized or when the motorcycle 100 is being irregularly moved. In addition, since the service cloud 200 can track the location of the motorcycle 100 through the location identification unit 112 of the observation apparatus 110, the current location of the motorcycle 100 can be determined at any time.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. An observation system for a vehicle, comprising:
an observation apparatus disposed in the vehicle, comprising:
a location identification unit producing a location information;
a movement identification unit producing a movement information; and
a long distance wireless communication unit; and
one or more servers, comprising:
a long distance wireless communication module communicating with the observation apparatus through the long distance wireless communication unit of the observation apparatus;
a data module storing a vehicle information of the vehicle; and
an analysis module;
wherein when the vehicle is not in operation,
the observation apparatus transmits a first movement warning message comprising the location information to the one or more servers when the movement information matches a burglar model, and transmits a second movement warning message to the one or more servers when the movement information matches a suspicious burglar model; and
the analysis module of the one or more servers compares the vehicle information with an advanced burglar model in response to the second movement warning message.

2. The observation system of claim 1, wherein the movement identification unit of the observation apparatus includes a gravity sensor producing an inertia information and a gyroscope producing an orientation information, the movement information comprises the inertia information and the orientation information, the movement information matches the burglar model when the location information, the inertia information, and the orientation information respectively exceed a first location variation value, a first inertia variation value, and a first orientation variation value during a period of time.

3. The observation system of claim 2, further comprising a lock mechanism disposed in the vehicle, wherein the lock mechanism can be unlocked to allow an engine of the vehicle to be started and locked to disallow the engine of the vehicle to be started, wherein the movement information matches the burglar model when the location information, the inertia information, and the orientation information respectively exceed the first location variation value, the first inertia variation value, and the first orientation variation value during a period of time, the lock mechanism is locked, and the engine of the vehicle is stopped.

4. The observation system of claim 1, further comprising a lock mechanism disposed in the vehicle, wherein the lock mechanism can be unlocked to allow an engine of the vehicle to be started and locked to disallow the engine of the vehicle to be started, the movement identification unit of the observation apparatus includes a gravity sensor producing an inertia information and a gyroscope producing an orientation information; the movement information comprises the inertia information and the orientation information, wherein the movement information matches the suspicious burglar model when the location information, the inertia information, and the orientation information respectively exceed a second location variation value, a second inertia variation value, and a second orientation variation value during a period of time, the lock mechanism is unlocked, and the engine of the vehicle is stopped.

5. The observation system of claim 1, wherein the second movement warning message comprises the location information, the vehicle information comprises the location information and a usage record of the vehicle.

6. An observation apparatus for a vehicle, comprising:
a location identification unit producing a location information;
a movement identification unit producing a movement information; and
a long distance wireless communication unit communicating with one or more servers through a long distance wireless network;
wherein the observation apparatus transmits a first movement warning message comprising the location information to the one or more servers when the movement information matches a burglar model, and transmits a second movement warning message comprising the location information to the one or more servers when the movement information matches a suspicious burglar model.

7. The observation apparatus of claim 6, wherein the movement identification unit includes a gravity sensor producing an inertia information and a gyroscope producing an orientation information, the movement information, the movement information comprises the inertia information and the orientation information, the movement information matches the burglar model when the location information, the inertia information, and the orientation information respectively exceed a first location variation value, a first inertia variation value, and a first orientation variation value during a period of time.

8. The observation apparatus of claim 7, wherein the movement information matches the burglar model when the location information, the inertia information, and the orientation information respectively exceed the first location variation value, the first inertia variation value, and the first orientation variation value during a period of time, a lock mechanism of the vehicle is locked to disallow an engine of the vehicle to be started, and the engine of the vehicle is stopped.

9. The observation apparatus of claim 6, wherein the movement identification unit includes a gravity sensor producing an inertia information and a gyroscope producing an orientation information, the movement information comprises the inertia information and the orientation information, the movement information matches the suspicious burglar model when the location information, the inertia information, and the orientation information respectively exceed a second location variation value, a second inertia variation value, and a second orientation variation value during a period of time, a lock mechanism of the vehicle is unlocked to allow an engine of the vehicle to be started, and the engine of the vehicle is stopped.

10. The observation apparatus of claim 6, wherein when the vehicle is in operation,
the observation apparatus acts on an engine controller of the vehicle to stop an engine of the vehicle and disables the engine controller in response to an engine stopping instruction received from the one or more servers.

11. The observation apparatus of claim 6, further comprising a data unit comprising parameters of the observation module and a short distance wireless communication unit communicating with a portable device, wherein the parameters of the observation module are modified through the portable device.

12. A server for a vehicular observation apparatus of a vehicle, comprising:
a long distance wireless communication module communicating with the vehicular observation apparatus through a long distance wireless network;
a data module storing an vehicle information of the vehicle; and
an analysis module comparing the vehicle information with an advanced burglar model in response to a second movement warning message received from the vehicular observation apparatus, wherein the second movement warning message is produced when a movement information of the vehicular observation apparatus matches a suspicious burglar model.

13. The server of claim 12, wherein the second movement warning message comprises the location information, the vehicle information comprises the location information and a usage record of the vehicle.

14. The server of claim 12, wherein the server transmits an engine stopping instruction to enable the observation apparatus to acts on an engine controller of the vehicle to stop an engine of the vehicle and disable the engine controller.
